(19) United States
(12) Patent Application Publication
(10) Pub. No.: US 2022/0198079 A1
(43) Pub. Date: Jun. 23, 2022

(54) Systems and Methods for Generating Jewelry Designs and Models using Machine Learning

(71) Applicant: BLNG Corporation, Los Angeles, CA (US)

(72) Inventors: Dumëne Comploi, Los Angeles, CA (US); Valerie Leblond, Los Angeles, CA (US)

(73) Assignee: BLNG Corporation, Los Angeles, CA (US)

(21) Appl. No.: 17/645,937

(22) Filed: Dec. 23, 2021

Related U.S. Application Data
(60) Provisional application No. 63/130,118, filed on Dec. 23, 2020.

(51) Int. Cl. G06F 30/12

(52) U.S. Cl. CPC G06F 30/12

(57) ABSTRACT

Systems and methods for generating jewelry designs and models using machine learning are disclosed. In one embodiment, generating a custom jewelry design based on user preferences using machine learning includes displaying a graphical user interface in a first interface mode with visual elements for indicating user preferences, capturing user input indicative of a user's preferences, saving parameter values associated with the user's preferences to a user profile, providing the saved parameter values to a machine learning model as input and obtaining an output jewelry model, and displaying the output jewelry model on the graphical user interface.

### CROSS-REFERENCE TO RELATED APPLICATIONS

The current application claims priority to U.S. Provisional Application No. 63/130,118, entitled “Systems and Methods for Generating Jewelry Designs and Models Using Machine Learning” to Comploi et al., filed Dec. 23, 2020, the disclosure of which is incorporated herein by reference in its entirety.

### BACKGROUND

Many people prefer custom-designed jewelry rather than generic off-the-shelf products. This is particularly true for gifts of love like engagement rings as well as other heirlooms with their sentimental value and considerable expenditure. As jewelry buyers no longer seek celebrity brands or products meant for the masses, jewelry personalization is exponentially growing. The trends show customers care more about personal expression, individuality and authenticity. Fully customized jewelry design is typically a complex process that requires expertise only reserved to a few. On the other hand, some businesses offer simple built-to-order strategies with minimal customization.

### SUMMARY OF THE INVENTION

Systems and methods for generating jewelry designs and models using machine learning are disclosed. In one embodiment, generating a custom jewelry design based on user preferences using machine learning includes displaying a graphical user interface in a first interface mode with visual elements for indicating user preferences, capturing user input indicative of a user's preferences, saving parameter values associated with the user's preferences to a user profile, providing the saved parameter values to a machine learning model as input and obtaining an output jewelry model, and displaying the output jewelry model on the graphical user interface.

In another embodiment, the graphical user interface is in a first interface mode and displays an example piece of jewelry and requests a positive or negative preference; and

In an additional embodiment, the captured user input indicates a positive preference.

In yet another embodiment, the graphical user interface is in a second interface mode and displays controls for jewelry design parameters and current values of the jewelry design parameters and the captured user input indicates changing a value of one of the jewelry design parameters.

In another embodiment again, the graphical user interface is in a third interface mode and displays a drawing interface with two drawing panels, a first panel showing visual indicators of user input and a second panel showing the output jewelry model, and the captured user input includes lines drawn by hand within the first drawing panel on the graphical user interface.

In still another embodiment, the graphical user interface is in a third interface mode and displays a drawing interface with one drawing panel, and visual indicators of user input are overlaid over the displayed output jewelry model; and

wherein the captured user input includes lines drawn by hand within the drawing panel on the graphical user interface.

Yet another embodiment also includes capturing user input indicating to change the display to a different interface mode, and changing the display of the graphical user interface to the indicated interface mode.

Another embodiment again includes determining matching items from a jewelry and accessories database to suggest pairing with the output jewelry model and displaying at least some of the matching items on the graphical user interface.

A further embodiment includes generated training data for the machine learning model by creating new combinations of parameter values.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The description and claims will be more fully understood with reference to the following figures and data graphs, which are presented as exemplary embodiments of the invention and should not be construed as a complete recitation of the scope of the invention.

FIG. 1 conceptually illustrates a computing system for machine learning assisted jewelry design in accordance with several embodiments of the invention.

FIG. 2 conceptually illustrates a remote computing system for machine learning assisted jewelry design in accordance with several embodiments of the invention.

FIG. 3A conceptually illustrates a server system for machine learning assisted jewelry design in accordance with several embodiments of the invention.

FIG. 3B conceptually illustrates a client system for machine learning assisted jewelry design in accordance with several embodiments of the invention.

FIG. 4A illustrates example images of beauty pass and object ID matte in accordance with several embodiments of the invention.

FIG. 4B illustrates images used in machine learning in accordance with several embodiments of the invention.

FIG. 5 illustrates an example graphical user interface screen in an “explorer mode” of machine learning assisted jewelry design in accordance with several embodiments of the invention.

FIG. 6 illustrates an example graphical user interface screen in a “creator mode” of machine learning assisted jewelry design in accordance with several embodiments of the invention.

FIGS. 7 and 8 illustrate an example graphical user interface screen in an “artist mode” of machine learning assisted jewelry design in accordance with several embodiments of the invention.

FIGS. 9 and 10 illustrate functional components of different versions of a graphical user interface in artist mode in accordance with several embodiments of the invention.

FIG. 11 illustrates a process for utilizing a graphical user interface for machine learning assisted jewelry design in accordance with several embodiments of the invention.

FIG. 12 illustrates a process for pairing and providing recommendations for additional jewelry pieces in accordance with an embodiment of the invention.

FIG. 13 shows an example graphical user interface screen where the display overlays a rendering of the design over the actual 3D printed ring in accordance with an embodiment of the invention.

### DETAILED DISCLOSURE OF THE INVENTION

Turning now to the drawings, systems and methods for generating jewelry designs and models using machine learning in accordance with embodiments of the invention are disclosed. Many embodiments of the invention provide a user-friendly graphical interface for selecting and manipulating jewelry designs on a client device. In some embodiments, the client device includes a machine learning model that can be used to generate recommendations based on user preferences about the appearance of a jewelry piece (e.g., likes and dislikes) captured in an interactive format, as will be discussed further below.

In other embodiments, the machine learning model is implemented on a server and the client device captures the user input. The client device may communicate choices of designs and/or parameters that characterize a design or designs, or user preferences or other information (e.g., a user preference profile) generated from user input, to a jewelry design AI server. The jewelry design AI server may use the selected designs to generate additional designs to present back to a user. In several embodiments, the jewelry design AI server uses the selected designs as input to a machine learning model that outputs one or more additional designs.

Systems and methods in accordance with embodiments of the invention can deliver a jewelry design that is personal, affordable, and well-engineered by combining technologies like machine learning, recommendation algorithms, and parametric design to accelerate and automate the design process. Further embodiments of the invention can provide a powerful previsualization tool to simulate realistic results that can be previewed and adjusted in real-time. In certain embodiments of the invention, a second layer of intelligence can include an optimization engine that minimizes cost, sources material, and/or generates machine codes for robotic production.

Additional features can include autonomously generating thousands of new designs and pairings to choose from or modify, as well as an entire personalized collection of different types of jewelry and accessory items for future acquisition by a user. Embodiments of the invention can deliver personalized design, real-time visualization, and value engineering in a streamlined product. The systems and methods described below involve creating designs of jewelry pieces, which can be any of a number of types of jewelry, such as, but not limited to, rings (wedding bands, engagement rings, etc.) necklaces, bracelets, etc. Additional embodiments of the invention can create designs for other types of objects as well.

### Systems for AI Jewelry Design

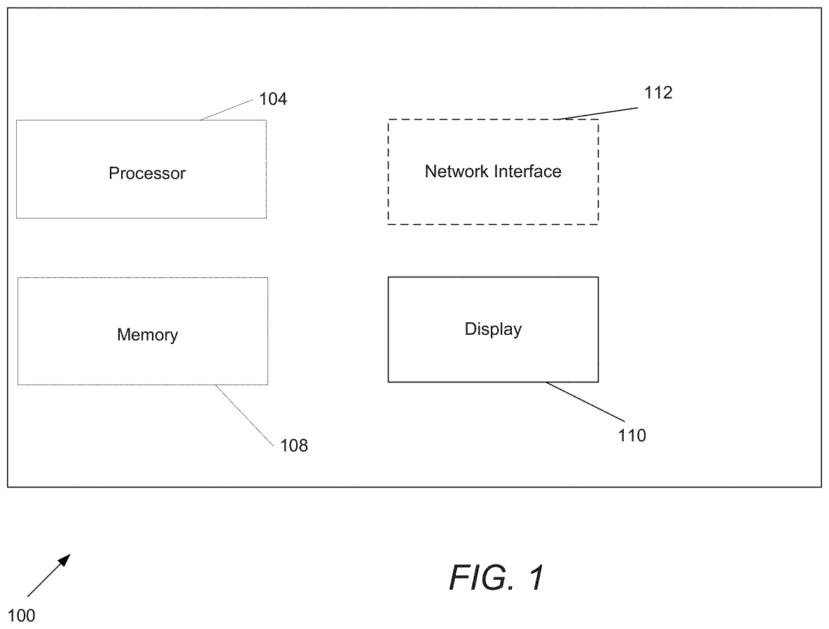

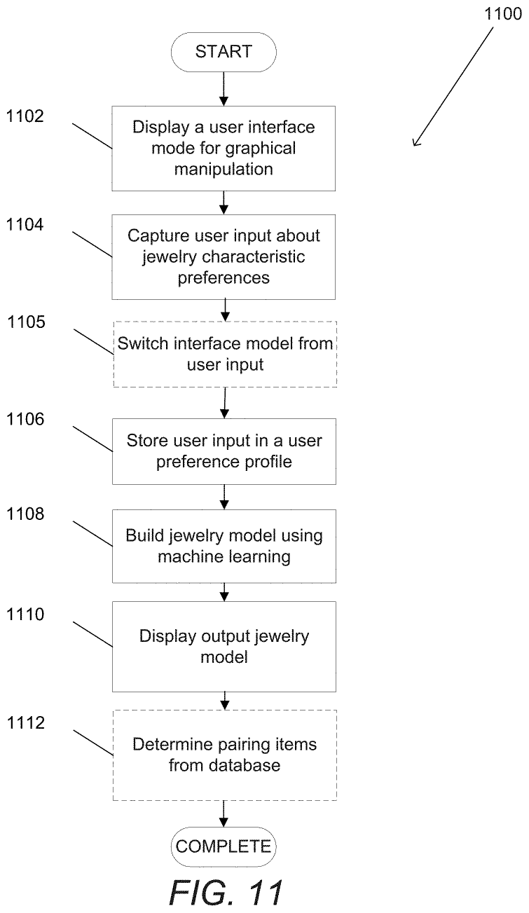

A system for AI jewelry design on a single platform in accordance with some embodiments of the invention may be implemented in a computer system, such as the one conceptually illustrated in FIG. 1. The system includes a processor 104, memory 108, display 110 that can show a graphical user interface, and network interface 112. Memory 108 can include instructions for a design application that can direct processor 104 to execute a machine learning model for generating jewelry piece models in response to user input, as will be discussed further below. Memory 108 can also include one or more databases, such as, but not limited to, a designer profile database, a user interaction asset database, a training data asset database, and/or a jewelry pairing database. As will be discussed further below, a designer profile database can store designer profiles. Asset databases and pairing databases can be used through a jewelry design process as described below, such as the one discussed with respect to FIG. 11.

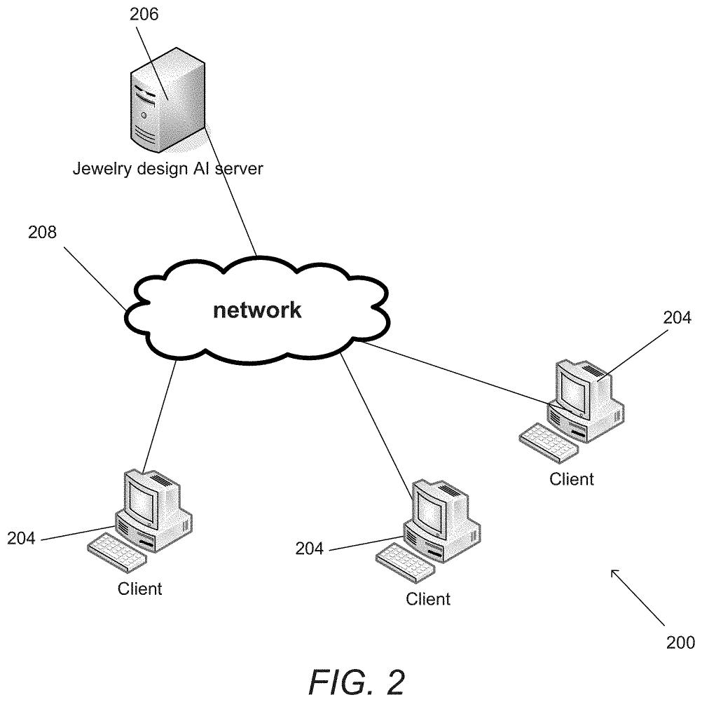

Another system for AI jewelry design in accordance with additional embodiments of the invention may be implemented in a networked computing system having a client and server that interact, such as the one conceptually illustrated in FIG. 2. The jewelry design system 200 includes one or more clients 204 and a jewelry design AI server 206 that can communicate over a network 208.

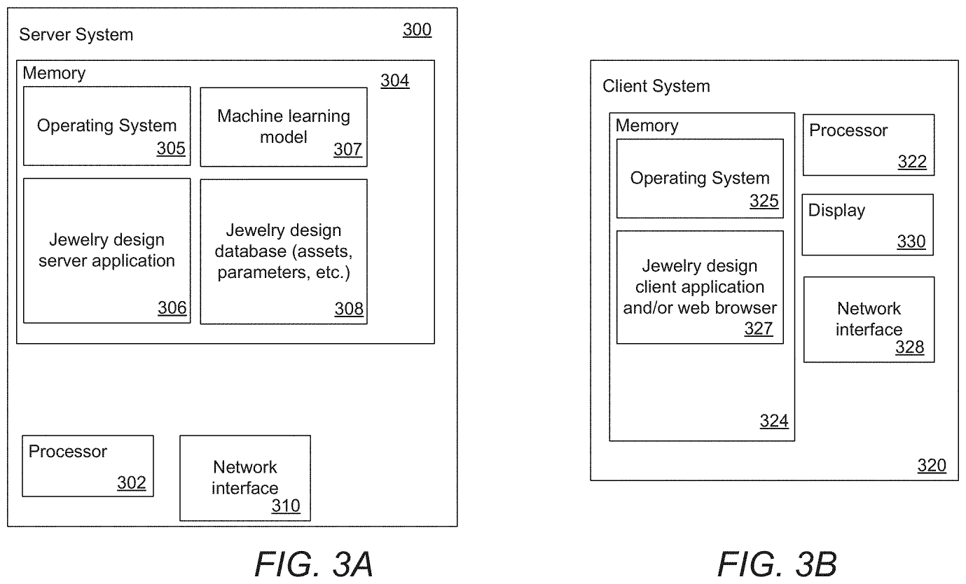

A server system in accordance with an embodiment of the invention is conceptually illustrated in FIG. 3A. The server 300 includes memory having an operating system 305, a jewelry design server application 306, a machine learning model 307, and a jewelry design database 308. It also includes a processor 302 and network interface 310.

A client system in accordance with an embodiment of the invention is conceptually illustrated in FIG. 3B. The client system includes memory having an operating system 325 and a jewelry design client application 327. It also includes a processor 322, a display 330, and a network interface 328.

In some embodiments, the server system is a web server that can provide clients using a web browser with a graphical user interface within a web page. The client system can receive and display the web page. Different types of graphical user interfaces for jewelry design are discussed further below. In other embodiments, the client system includes a jewelry design application and can receive information from the server system for what to display within a graphical user interface and can provide captured information, or processed information (e.g., a user preference profile built from captured user input) back to the server system.

Although specific architectures are discussed above with respect to FIGS. 1-3B, one skilled in the art will recognize that any of a variety of computing systems may be utilized in accordance with embodiments of the invention. Assets and training data are discussed next.

### Asset Generation and Preparing Training Data

In several embodiments of the invention, assets can be used as reference points to be presented to a user in a graphical user interface to guide through a design process and/or as training data for machine learning models. Assets can include digital representations of specific designs for particular types of jewelry, which can be in formats that are 2-dimensional (e.g., images) and/or 3-dimensional (e.g., CAD or other 3D representations). Ideally, the viewpoint of 2D images should be the same (e.g., top views, ¾ perspective views, etc.). In different embodiments, different views can be included. For example, just two views (top view and ¾ perspective view) or multiple views (top, bottom, left, right, perspective).

For use in training a machine learning model, assets can be further described in ways such as being segmented and/or labeled. In some embodiments, segmenting and labeling can be done manually and stored. In other embodiments, a machine learning model can be used to segment and label in an automated manner.

Two dimensional (2D) images and three-dimensional (3D) models can be stored in a database and/or can be represented by a parametric definition (i.e., via variable parameters), which may be changed by user interaction in real-time as will be described further below. Some various embodiments of the invention may utilize 150-300 variables to define a model of a jewelry piece. For example, parameters for a jewelry piece that is a ring may include, but are not limited to, ring size, profile height/width, profile type, gem, and carat. A list of 18 parameters that may be utilized in certain embodiments of the invention to characterize a ring is shown below in Table 1:

TABLE 1

| | | |
|---|---|---|
| Ring Diameter (Finger size) | Width of the band | Thickness of the band |
| Radius (band profile) | Shape of the band profile | Type of diamond |
| Number of carats | Type of sideGems | Type of haloGems |
| Number of Prongs | Prongs-settingType | Ring Typology |
| Accent Stone color | Accent Stone type | Band Accent Type |
| Band Accent Angle | Color of the Band | Color of the Center stone |

In addition, definitions of 2D and 3D models can be characterized in terms of layers or passes that would be utilized in rendering the model visually. Rendering in layers can include rendering different objects in a scene separately, so that a different image is rendered for each layer of objects. Rendering in passes can include rendering different attributes separately, such that each pass contributes a different type of information or aspect of the scene.

For visualization, a type of 2D images utilized can be beauty pass. Beauty pass often refers to the main, full color rendering of the subject, typically including aspects such as diffuse illumination, color, and color maps but not reflections, highlights, or shadows. Beauty pass can alternatively refer to the final rendering with all aspects of the subject.

For classification, types of 2D images utilized can be object ID mattes (region of an object: band, gem, halo, etc.) and instance mattes (types or values that further detail a region, e.g., type of gem, shape of band, etc.).

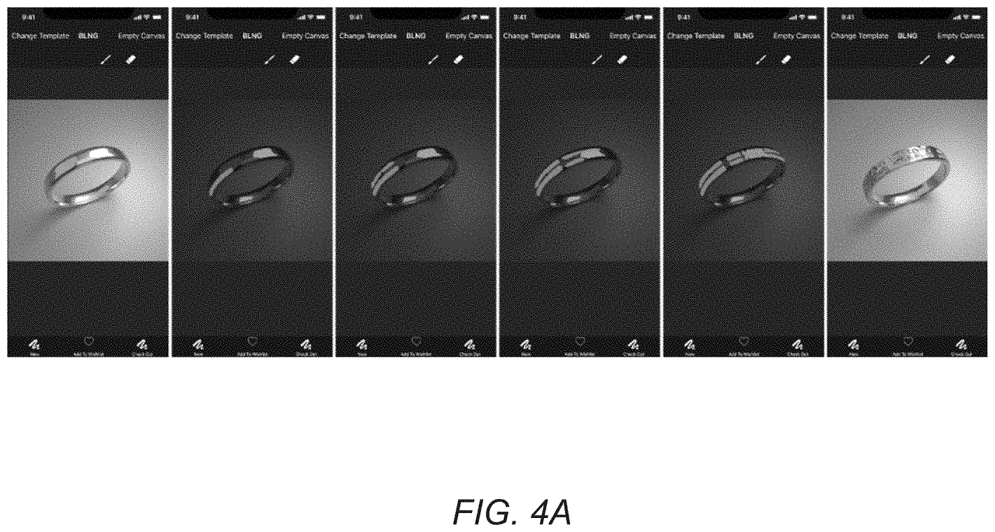

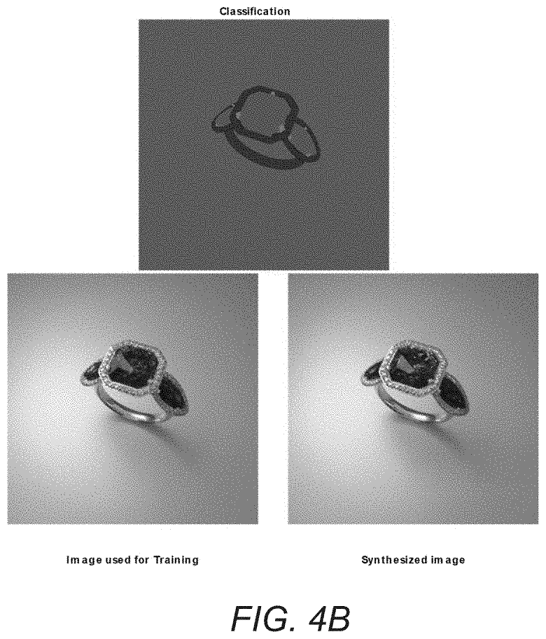

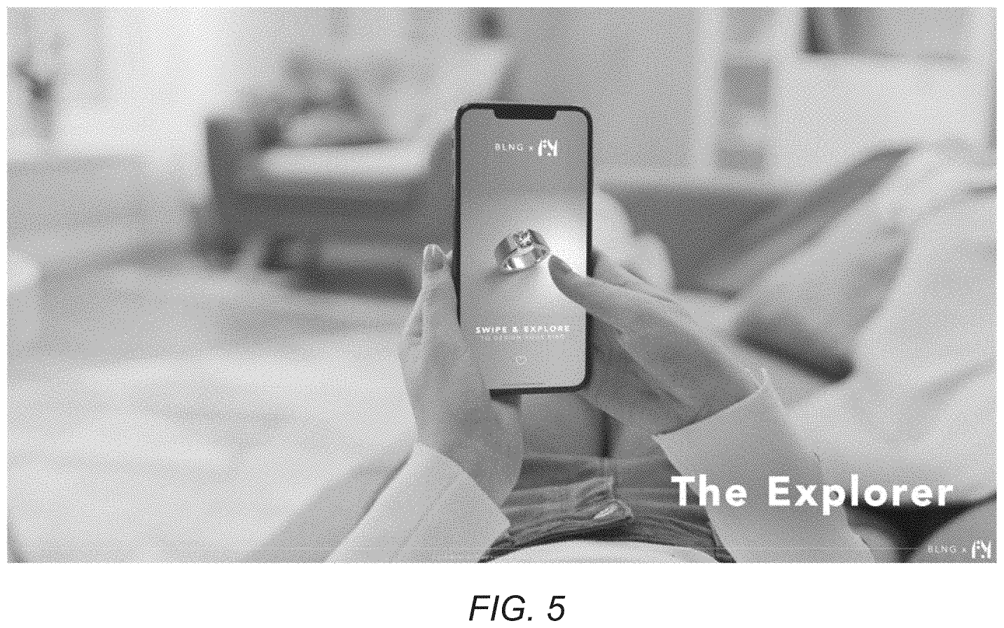

An example sequence of images showing the combination of a beauty pass and an object ID matte for a ring model in accordance with an embodiment of the invention is illustrated in FIG. 4A.

In further embodiments of the invention, an AI generator (machine learning model) can be used to synthesize new assets by selecting elements from a data library.

In many embodiments of the invention, the system stores a set of assets for user interaction and a set of assets for training a machine learning model. User interaction assets can be used to guide a user in selecting and narrowing down their preferences in the configuration of their desired jewelry piece, such as in the interfaces as described further below. In several embodiments, training assets are sought to be unbiased (e.g., more common designs or those expected to be selected by more users have more examples included, while designs that are more rare or less frequently chosen have fewer examples included).

The training data assets can be used to train a machine learning model, such as NVidia Gaugan, Pix2Pix, or other types including convolutional neural networks, to create a 2D or 3D model given inputs that are determined by user interaction. Example images of a ring model in accordance with an embodiment of the invention are illustrated FIG. 4B. The source image used for training is shown on the lower left. The components of the model broken down into a classification is shown on the upper center. A synthesized image output of the machine learning model is shown on the lower right. As can be seen by the input and output images, the machine learning model is quite accurate in reproducing a jewelry piece given a particular set of parameters. As will be discussed below, a graphical user interface can be used to capture user preferences for a particular jewelry piece that they would like to build.

### Design Interface Modes

Once a machine learning model is created or refined, it can be used in combination with user input to generate jewelry designs from user input. In several embodiments of the invention, user input can be captured on a graphical user interface and used to build a “designer profile” that stores user preferences about the characteristics of a piece of jewelry. The preferences can be saved, for example, as database entries. The designer profile can be used to select input data to provide to the machine learning model for generating a jewelry item according to the user's preferences.

Any of a variety of types of user interfaces may be utilized in accordance with embodiments of the invention. Several examples are discussed below, referred to as “modes” where the features for a user interact with the user interface are different.

FIG. 5 illustrates an example graphical user interface screen in an “explorer mode” of machine learning assisted jewelry design in accordance with several embodiments of the invention.

In an “Explorer” mode, the jewelry design system can build and update a designer profile by visually presenting jewelry pieces on the user interface to a user. The user can confirm or decline their preference for each particular piece via user input that can include clicking or swiping on a portion of the user interface (e.g., clicking a button or swiping in a direction). The jewelry design system can save values for certain parameters associated with pieces that are presented and indicated as having a positive preference by the user, and may save parameters for pieces having a negative preference as well. In several embodiments of the invention, the saved parameters can be provided to a machine learning model to generate a jewelry design for the user. In some embodiments, the saved parameters can be used to select a subset of jewelry pieces from a database to provide to a machine learning model to generate a jewelry design. In some embodiments, the parameters are used in the machine learning model or the selection process with a weighting. The machine learning model can be used to find patterns in the selections and determine next images/designs to present to a user to guide the selection process.

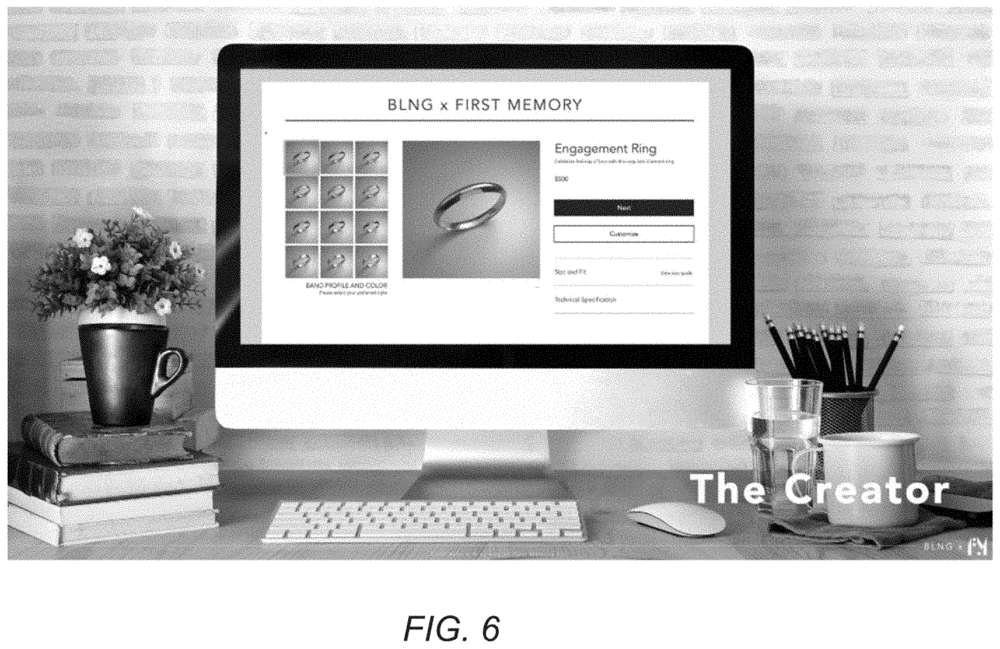

FIG. 6 illustrates an example graphical user interface screen in a “creator mode” of machine learning assisted jewelry design in accordance with several embodiments of the invention.

In a “Creator” mode, a user can enter or select specific parameters in the user interface. The interface can present the effect of varying parameters in any of a variety of ways, e.g., changing a preview image to reflect changed parameters or showing thumbnail preview images side-by-side. Similar to the explorer mode, characteristics can be extracted from the selected designs to build a designer profile and/or a ring profile.

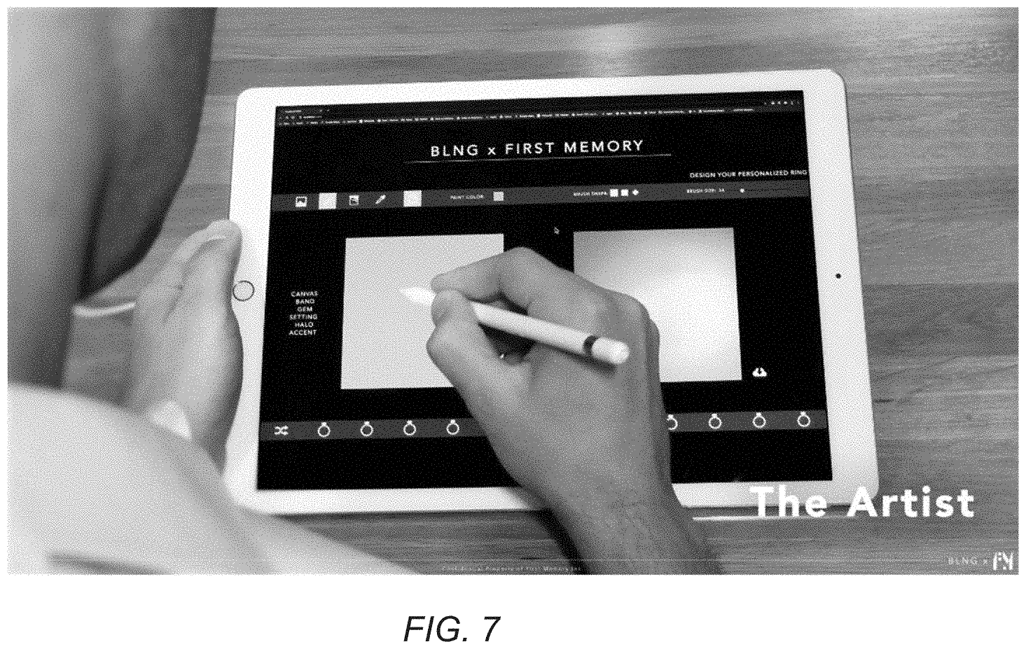

FIG. 7 illustrates an example graphical user interface screen in an “artist mode” of machine learning assisted jewelry design in accordance with several embodiments of the invention.

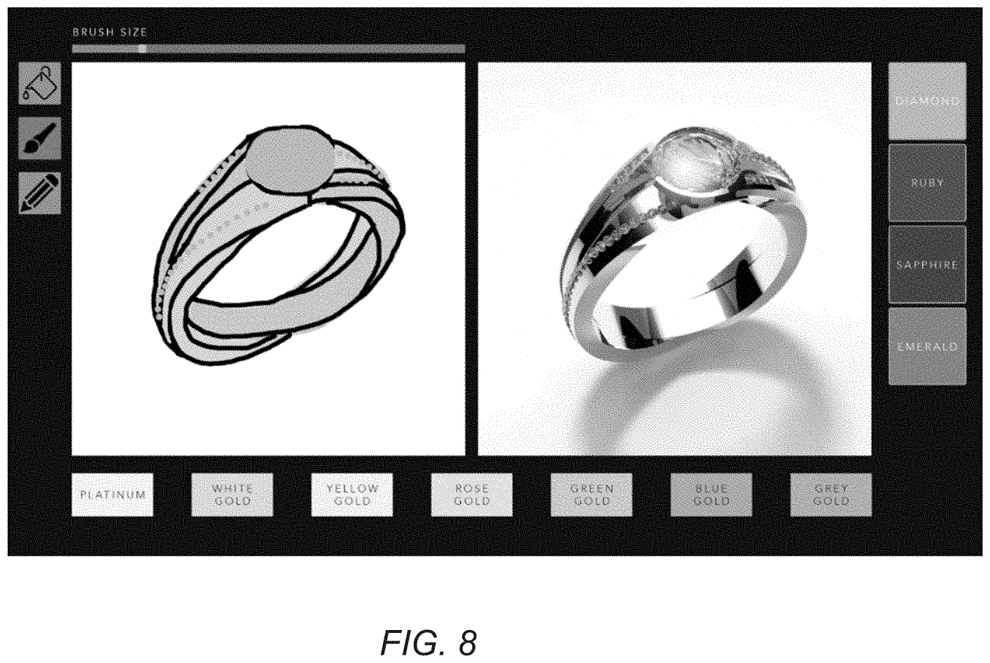

In an “Artist” mode, the graphical user interface can provide a freehand drawing area and drawing tools (e.g., line size, color, etc.) for a user to sketch a drawing of a jewelry piece. Parameters can be extracted from the sketch that is created. In several embodiments, a color palette of different colors can represent different components of a jewelry piece, e.g., on a ring: white for the band, blue for the gem, navy blue for prongs, ocean blue for accents, and purple for halo. The user interface can allow a user to select a color from the palette and draw their desired design. As with the other modes, characteristics can be extracted from the created design to build a designer profile and/or a ring profile. FIG. 8 illustrates a side-by-side mode in accordance with some embodiments of the invention, where the user's input is shown on the left image, while the output design is shown in a realistic render on the right image. Other embodiments of the invention show a single image where the user input is shown overlaid on the output image.

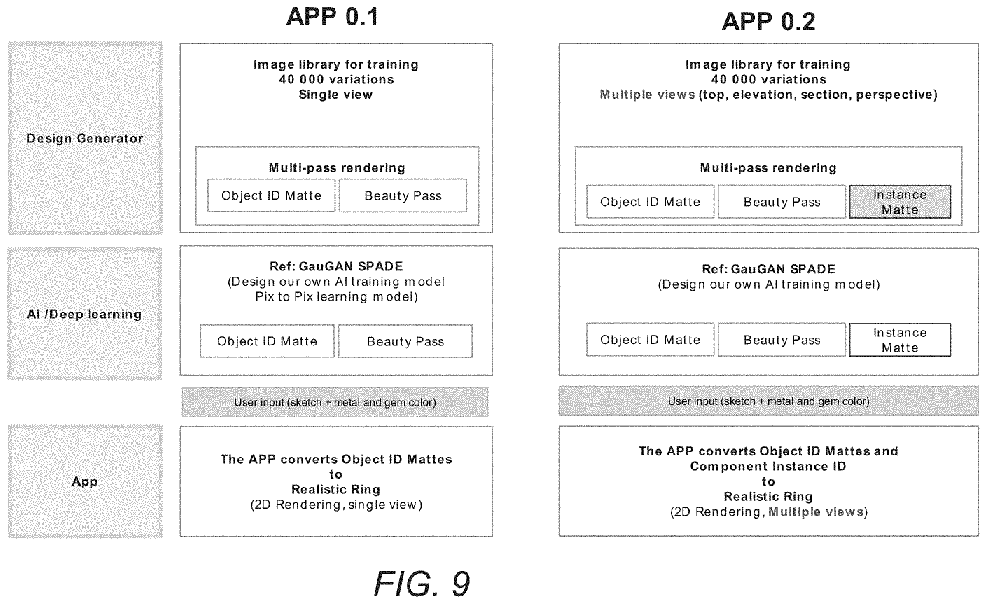

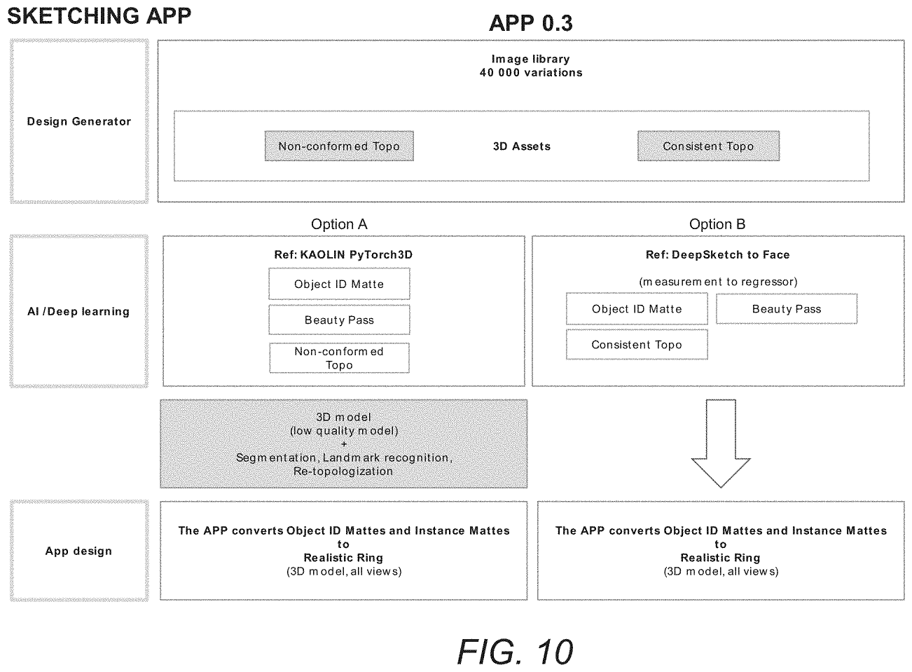

FIGS. 9 and 10 illustrate functional components of different versions of a graphical user interface in artist mode in accordance with several embodiments of the invention. In a first 0.1 version, generating a design involves rendering in two passes. An object ID matte provides guidance on what objects are where in the design and the classification of objects by using a different color for each object. A beauty pass provides details to the final appearance such as adding surface textures and lighting effects.

The rendering can be applied to training data, which can be provided to a machine learning model to train as input data. The rendering can also be applied to a freehand sketch created by a user in artist mode. The sketch and a style guide can be provided to the machine learning model to generate an output rendered 3D model of the jewelry piece illustrated by the sketch. A style guide can include a beauty pass image that defines what colors in the image represent. For example, common combinations of materials can be defined by style guides (e.g., sapphire with rose gold, brilliant with diamond). Benefits of the machine learning model can include details such as making the reflection of a gem in other metal portions of a ring to correspond to the correct color of the gem. In a 0.2 version of the graphical user interface, the rendering can also include an instance matte that further defines subcomponents of certain objects (e.g., features of band or setting).

In a 0.3 version of the graphical user interface, assets and rendering can also include topology, that is topological properties and/or features of objects to make the rendering more realistic by adding conformities and checks. Conformed topology can be understood as a reduced representation such that an image or model is more comparable with other images or models. For example, a conformed topological image can include the same number of vertex points and polygons as others.

In Option A utilizing non-conformed topology, the output of the machine learning model may be a low-quality model. Segmentation, landmark recognition, and re-topologization may be performed to clean up the model to be more realistic. Semantic segmentation can be seen as recognizing that certain features should be present and their relative position. In Option B utilizing conformed topology, a parametric model that is conformative can work as a regressor, moving coordinates in space, so that less correction is needed to clean up the image.

Additional embodiments of the invention include the ability to convert 2D images to 3D models with different lighting effects to create additional perspective views.

In further embodiments of the invention, the user interface can switch from one mode to another. Furthermore, the saved data within one mode can be transferred to another. In this way, the data stored as a designer profile can be refined by using different modes sequentially.

Once a designer profile and model of a jewelry piece is created using one or more of the above processes, the characteristics of the jewelry piece can be extracted to build a jewelry piece profile.

### Processes for Training Jewelry Design Machine Learning Model

As discussed above, machine learning models can be trained to generate new jewelry piece designs when given captured user preferences as input. Further embodiments of the invention can include creating training data of images of jewelry pieces that are not necessarily photos of actual jewelry, but artificially constructed as synthetic data to have desired parameters. Some embodiments utilize 40,000 source images to train the machine learning model, although other embodiments may utilize a different number of images.

Additional training data can be generated by creating new images or models from different possible combinations of parameters. The new combinations can be constrained by omitting combinations that do not make sense or would not be appealing. On the other hand, training data can be weighted by including more of some combinations that are known to be appealing.

### Processes for Creating Custom Jewelry Designs Using Machine Learning

A graphical user interface for customizing a jewelry design can be displayed to a user on a web page or using a client application. One such process according to some embodiments of the invention is illustrated in FIG. 11. The process 1100 includes displaying (1102) an initial graphical user interface. As discussed further above, a jewelry design system may be implemented as a single platform (e.g., with respect to FIG. 1) or as a client-server system (e.g., with respect to FIGS. 2, 3A, and 3B).

The initial graphical user interface can be one of the modes described above: explorer, creator, or artist mode. Elements that are displayed in the initial graphical user interface would be those associated with that particular mode. For example, explorer mode may display an example piece of jewelry to capture the user's preference (e.g., preferred or not preferred). The user can choose their preference by indicating by a control on the screen, e.g., swiping in a particular direction (left or right) or selecting a button (yes or no) on the display.

Creator mode may display controls for a set of parameters, the possible values and/or current selected value of each shown parameter, and/or thumbnail previews illustrating the effect of particular values of a parameter. It may also display a main preview image of a piece of jewelry having parameters set to the current selected values.

Artist mode may display a drawing area, a preview area, and drawing controls. In some embodiments, the drawing area and preview area may coincide. In these embodiments, the preview image can change while the user draws on it.

The graphical user interface may allow the user to switch (1105) from one mode to another (e.g. from artist mode to creator mode), while carrying over the user's current selections (designs, parameters, etc.).

The process includes capturing (1104) user input that is indicative of the user's preferences. The captured data and/or parameter values associated with the captured data can be stored (1106) in the database and can be used to create a user preference profile.

The parameter values, or 2D or 3D models of jewelry pieces that are associated with the user's preferences, can be provided to machine learning model as input to generate (1108) an output jewelry model.

The output jewelry model can be displayed (1110) on the graphical user interface.

In additional embodiments of the invention, pairing items are jewelry pieces or other personal accessories that can supplement the output jewelry model having visual appearances (e.g., similarities in color, pattern, shape, style, etc.) to match. Pairing items can be determined by the machine learning model and retrieved from a jewelry and accessory database to display on the graphical user interface.

Although a specific process for generating jewelry designs is discussed above with respect to FIG. 11, one skilled in the art will recognize that any of a variety of processes may be utilized in accordance with embodiments of the invention. Some embodiments may be implemented as a single platform system. Other embodiments may be implemented as a client-server system where a web server provides web page(s) showing the graphical user interface to the client system to display to a user. The client system can capture the user input and provide it back to the web server. The processing (machine learning model, etc.) can be carried out on the web server or another server. In even further embodiments of the invention, the client system can run a client application that shows a graphical user interface and provides information to a server system.

### Accessory Pairing

For additional purchase opportunities, it can be desirable to present a user with other types of jewelry to pair with the piece that they have created using a process such as those described above. For example, if the user has created a ring, additional jewelry items to suggest can include bracelets and necklaces.

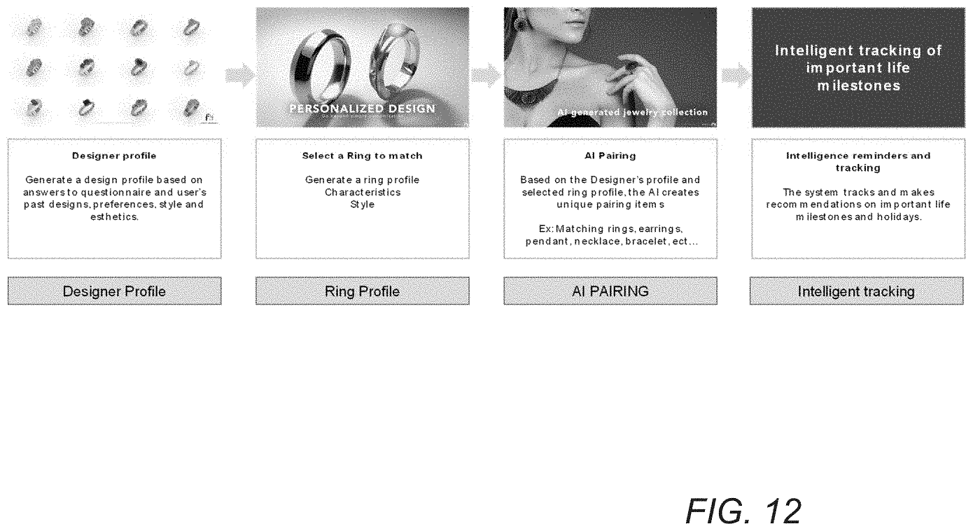

FIG. 12 illustrates a process for pairing and providing recommendations for additional jewelry pieces. The jewelry design system can utilize machine learning models to generate designs for additional jewelry items in a style that matches the piece that the user created (e.g., the same gems/metal, match the shape of bands, etc.).

### Extended Reality Visualization and Personal Fitting

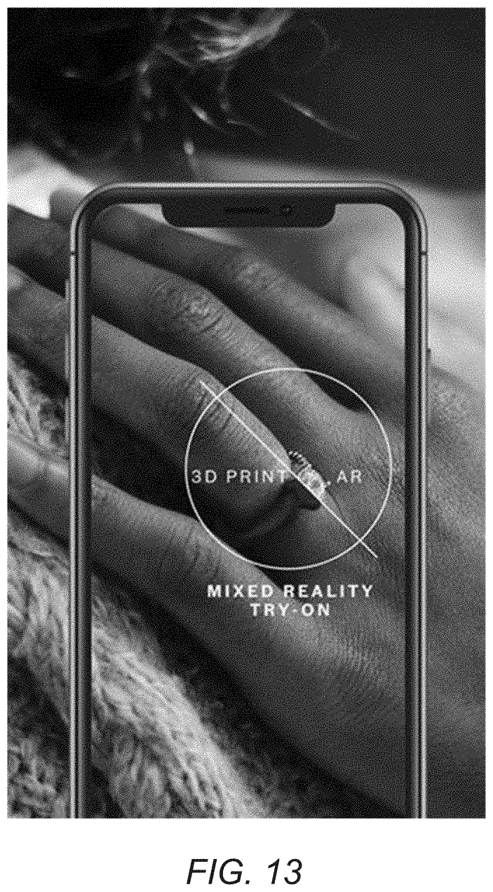

In further embodiments of the invention, the jewelry design system can provide extended reality visualization once the jewelry piece has been designed such when using a process such as the one described above with respect to FIG. 11. The system can generate a 3D printing file for physical production of the piece using 3D printing technology (e.g., wax print). The user can try on the 3D printed model of the designed piece (e.g., ring) for physical fitting. In some embodiments of the invention, the user can use a phone or a tablet to visualize the actual designed finish of the ring by viewing the ring in the camera of the phone or tablet. The image displayed on the screen of the phone or tablet can overlay the designed finish (i.e., having the parameters of the designed ring) over the 3D printed model. The 3D printed model can be used for tracking and synchronizing the physical and digital content (Extended Reality). FIG. 13 shows an example graphical user interface screen where the display overlays a rendering of the design over the actual 3D printed ring (blue).

### CONCLUSION

Although the description above contains many specificities, these should not be construed as limiting the scope of the invention but as merely providing illustrations of some of the presently preferred embodiments of the invention. Various other embodiments are possible within its scope. Accordingly, the scope of the invention should be determined not by the embodiments illustrated, but by the appended claims and their equivalents.

What is claimed is:

1. A method for generating a custom jewelry design based on user preferences using machine learning, the method comprising:
displaying a graphical user interface in a first interface mode with visual elements for indicating user preferences;
capturing user input indicative of a user's preferences;
saving parameter values associated with the user's preferences to a user profile;
providing the saved parameter values to a machine learning model as input and obtaining an output jewelry model; and
displaying the output jewelry model on the graphical user interface.

2. The method of claim 1, wherein the graphical user interface is in a first interface mode and displays an example piece of jewelry and requests a positive or negative preference; and
where the captured user input indicates a positive preference.

3. The method of claim 1, wherein the graphical user interface is in a second interface mode and displays controls for jewelry design parameters and current values of the jewelry design parameters;
wherein the captured user input indicates changing a value of one of the jewelry design parameters.

4. The method of claim 1, wherein the graphical user interface is in a third interface mode and displays a drawing interface with two drawing panels, a first panel showing visual indicators of user input and a second panel showing the output jewelry model; and
wherein the captured user input includes lines drawn by hand within the first drawing panel on the graphical user interface.

5. The method of claim 1, wherein the graphical user interface is in a third interface mode and displays a drawing interface with one drawing panel, and visual indicators of user input are overlaid over the displayed output jewelry model; and
wherein the captured user input includes lines drawn by hand within the drawing panel on the graphical user interface.

6. The method of claim 2, 3, 4, or 5, further comprising capturing user input indicating to change the display to a different interface mode; and
changing the display of the graphical user interface to the indicated interface mode.

7. The method of claim 1, further comprising determining matching items from a jewelry and accessories database to suggest pairing with the output jewelry model and displaying at least some of the matching items on the graphical user interface.

8. The method of claim 1, further comprising generated training data for the machine learning model by creating new combinations of parameter values.

9. The method of claim 1, wherein capturing user input indicative of a user's preferences is performed on a client device and providing the saved parameter values to a machine learning model as input and obtaining an output jewelry model is performed on a server system.

10. A system for generating a custom jewelry design based on user preferences using machine learning, the system comprising:
a processor;
non-volatile memory containing jewelry design application instructions;
where the jewelry design application instructions, when executed, configures the processor to:
display a graphical user interface in a first interface mode with visual elements for indicating user preferences;
capture user input indicative of a user's preferences;
save parameter values associated with the user's preferences to a user profile;
provide the saved parameter values to a machine learning model as input and obtaining an output jewelry model; and
display the output jewelry model on the graphical user interface.
